(19) United States
(12) Patent Application Publication
(10) Pub. No.: US 2019/0101710 A1
(43) Pub. Date: Apr. 4, 2019

(54) OPTICAL RECEPTACLE AND OPTICAL MODULE

(71) Applicant: Enplas Corporation, Saitama (JP)

(72) Inventor: Ayano KON, Saitama (JP)

(21) Appl. No.: 16/083,012

(22) PCT Filed: Feb. 20, 2017
(86) PCT No.: PCT/JP2017/006139

§ 371 Date: Sep. 7, 2018

(30) Foreign Application Priority Data
Mar. 7, 2016 (JP) 2016-043302

(51) Int. Cl. G02B 6/42

(52) U.S. Cl. CPC G02B 6/4204; G02B 6/4292

(57) ABSTRACT

An optical receptacle having a first optical surface, a second optical surface, a first engaging section, and a second engaging section. The first optical surface has incident thereto first emitted light emitted from a photoelectric conversion element. The second optical surface emits, towards an end surface of an optical transmission body, the first emitted light that has been incident to the first optical surface and has passed through the interior of the optical receptacle. The first engaging section is arranged on a first side surface that is different from the surface on which the first optical surface is formed and the surface on which the second optical surface is formed. The second engaging section is arranged on a second side surface facing the first side surface across an optical path for the first emitted light or a second emitted light.

### TECHNICAL FIELD

The present invention relates to an optical receptacle, and an optical module including the optical receptacle.

### BACKGROUND ART

Conventionally, in optical communications using an optical transmission member such as an optical fiber and an optical waveguide, an optical module including a light emitting element such as a surface-emitting laser (e.g. a vertical-cavity surface-emitting laser (VCSEL)) has been used. Such an optical module includes an optical receptacle that operates such that light containing communication information emitted from a light emitting element is incident on an end surface of the optical transmission member.

In recent years, the number of the cores of optical modules for optical communications using optical fibers generally increases with the increasing communication speed. In view of this, an optical receptacle including multiple channels for simultaneously transmitting and receiving multiple light beams containing communication information is used (see, for example, PTL 1).

The optical receptacle disclosed in PTL 1 includes a plurality of first optical surfaces that allow incidence of light emitted from a light-emitting element, a total reflection surface that reflects light having entered the optical receptacle from the first optical surface, and a plurality of second optical surfaces that emit light reflected by the total reflection surface toward an end surface of optical transmission member. The optical receptacle disclosed in PTL 1 is capable of optically coupling a plurality of photoelectric conversion elements with the end surfaces of a plurality of optical transmission members. In addition, the optical receptacle disclosed in PTL 1 is integrally shaped by injection molding with a thermoplastic transparent resin. To be more specific, the optical receptacle disclosed in PTL 1 can be manufactured by supplying thermoplastic transparent resin into a cavity of a metal mold, and then by releasing the optical receptacle after cooling and solidifying the resin.

### CITATION LIST

### Patent Literature

PTL 1

Japanese Patent Application Laid-Open No. 2009-163212

### SUMMARY OF INVENTION

### Technical Problem

However, the optical receptacle disclosed in PTL 1 needs newly manufactured metal molds when the number of the cores is further increased, and as such requires large manufacturing time and manufacturing cost for the metal mold. In addition, optical receptacles including twelve channels or greater channels are still not sufficiently standardized, and the variety of such optical receptacles is still poor. Moreover, the demand for increasing the number of channels in the future cannot be predicted.

An object of the present invention is to provide an optical receptacle which can freely adjust the number of channels in accordance with the required channel number. In addition, another object of the present invention is to provide an optical module including the optical receptacle.

### Solution to Problem

An optical receptacle according to an embodiment of the present invention is configured to be disposed between a photoelectric conversion element and an optical transmission member, and configured to optically couple the photoelectric conversion element with an end surface of the optical transmission member, the optical receptacle including: a first optical surface configured to allow incidence of first emission light emitted from the photoelectric conversion element, or to emit, toward the photoelectric conversion element, second emission light which has been emitted from the end surface of the optical transmission member and has passed through inside of the optical receptacle; a second optical surface configured to emit, toward the end surface of the optical transmission member, the first emission light which has entered the optical receptacle from the first optical surface and has passed through the inside of the optical receptacle, or to allow incidence of the second emission light emitted from the end surface of the optical transmission member; a first fitting part disposed in a first side surface which is neither a surface in which the first optical surface is formed nor a surface in which the second optical surface is formed; and a second fitting part disposed in a second side surface which is opposite to the first side surface with a light path of the first emission light or a light path of the second emission light therebetween, the second fitting part having a shape capable of being fitted to the first fitting part.

An optical module according to an embodiment of the present invention includes:

a substrate; a photoelectric conversion element disposed on the substrate; and a plurality of the optical receptacles according to any one of claims 1 to 6, the plurality of the optical receptacles being disposed on the substrate such that the first optical surface is opposite to the photoelectric conversion element. The plurality of optical receptacles are coupled with each other such that the first fitting part and the second fitting part adjacent to each other are engaged with each other.

### Advantageous Effects of Invention

According to the present invention, the number of the channels of the optical receptacle and the optical module can be freely changed in accordance with the required number of the channels. Since it is unnecessary to newly manufacture the metal mold in accordance with the required number of the channels, the manufacturing time and manufacturing cost for the metal mold are not increased.

### BRIEF DESCRIPTION OF DRAWINGS

FIG. 1 is a sectional view schematically illustrating a configuration of an optical module according to an embodiment;

FIGS. 2A to 2F illustrate a configuration of an optical receptacle according to the embodiment;

FIG. 3 is a schematic view for describing arrangement of a first fitting part and a second fitting part; and

FIGS. 4A to 4F illustrate a configuration of an optical receptacle according to Modification 1 of the embodiment.

### DESCRIPTION OF EMBODIMENTS

An embodiment of the present invention is elaborated below with reference to the accompanying drawings.

### Configuration of Optical Module

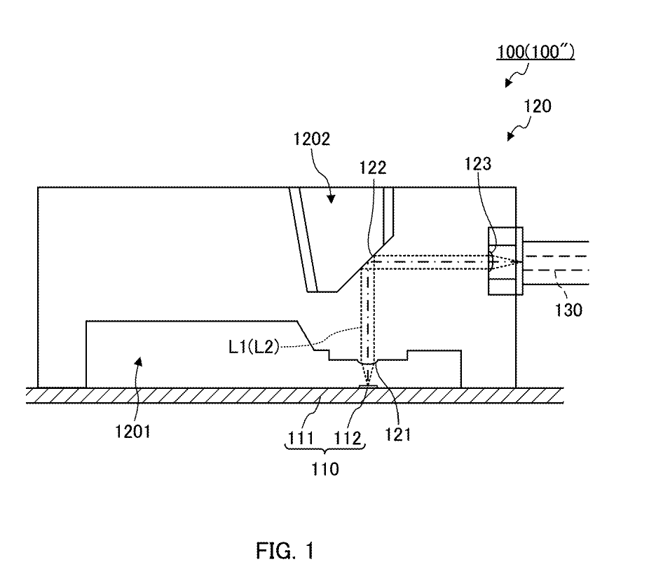

FIG. 1 is a sectional view schematically illustrating a configuration of optical module 100 according to the embodiment of the present invention. In FIG. 1, hatching of the cross-section of optical receptacle 120 is omitted to illustrate the light path in optical receptacle 120. In addition, in FIG. 1, the dashed line indicates an optical axis, and the broken line indicates an outer diameter of light.

As illustrated in FIG. 1, optical module 100 includes photoelectric conversion device 110 and a plurality of optical receptacles 120. Optical module 100 according to the present embodiment is a transmitting optical module. Optical module 100 is used in the state where optical receptacle 120 is connected with a plurality of optical transmission members 130.

Photoelectric conversion device 110 includes substrate 111 and a plurality of photoelectric conversion elements 112.

Substrate 111 holds photoelectric conversion element 112. Substrate 111 is, for example, a glass composite substrate, a glass epoxy substrate, a flexible substrate or the like.

Photoelectric conversion element 112 is disposed on substrate 111. In optical module 100 according to the present embodiment, a light-emitting element, which serves as photoelectric conversion element 112, is disposed on substrate 111. In the present embodiment, a plurality of light-emitting elements are arranged on a straight line along the depth direction of FIG. 1.

The light-emitting element emits laser light in a direction perpendicular to the front surface of substrate 111. To be more specific, the light-emitting element emits laser light from a photoelectric conversion surface (light-emitting surface). The number and the position of the light-emitting element are not limited, and may be appropriately changed in accordance with the use. In the present embodiment, four light-emitting elements are associated with each of the optical receptacles 120. The light-emitting element is, for example, a vertical-cavity surface-emitting laser (VCSEL).

Optical receptacle 120 optically couples photoelectric conversion element 112 and the end surface of optical transmission member 130 in the state where optical receptacle 120 is disposed between photoelectric conversion element 112 and optical transmission member 130. Optical receptacle 120 emits, toward the end surface of optical transmission member 130, first emission light L1 emitted from photoelectric conversion element 112 (light-emitting element). The number of optical receptacles 120 is not limited as long as two or more optical receptacles 120 are provided, and may be appropriately set in accordance with the use. In the present embodiment, four optical transmission members 130 are associated with each of optical receptacles 120.

Photoelectric conversion device 110 and optical receptacle 120 are fixed to each other with a publicly known fixing means such as an adhesive agent (e.g. heat/ultraviolet curing resin).

Optical transmission member 130 is fixed on optical receptacle 120 with a publicly known attaching means in the state where optical transmission member 130 is housed in a multicore collective connector. The type of optical transmission member 130 is not limited. Examples of optical transmission member 130 include an optical fiber, a light waveguide, and the like. In the present embodiment, optical transmission member 130 is an optical fiber. In addition, the optical fiber may be of a single mode type, or a multiple mode type. The number of optical transmission member 130 is not limited, and may be appropriately changed in accordance with the use. In the present embodiment, a plurality of optical transmission members 130 are arranged on a straight line along the depth direction of FIG. 1.

### Configuration of Optical Receptacle

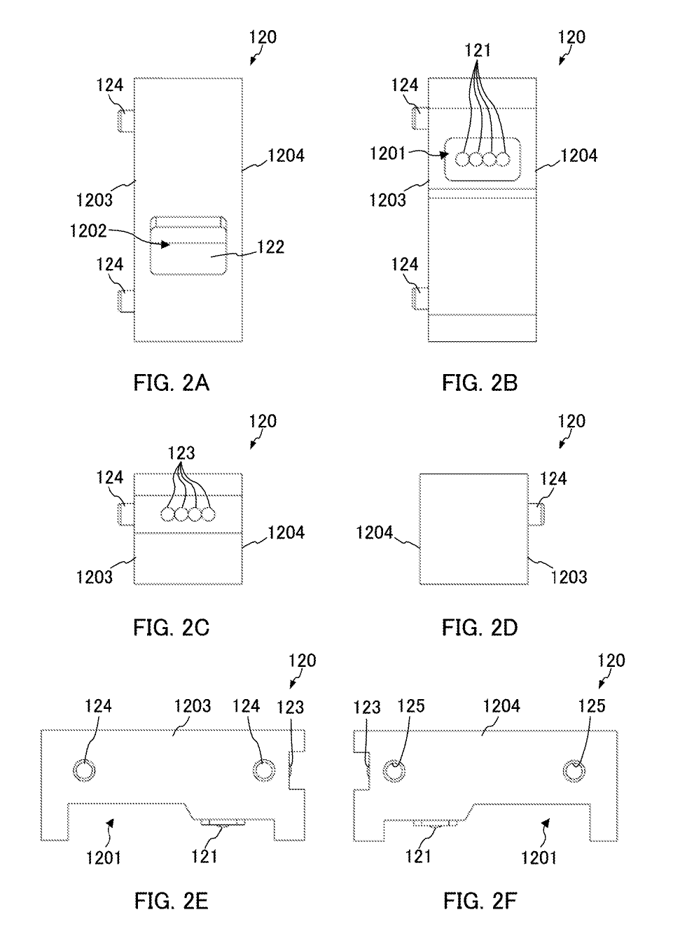

FIGS. 2A to 2F illustrate a configuration of optical receptacle 120 according to the present embodiment. FIG. 2A is a plan view of optical receptacle 120, FIG. 2B is a bottom view of optical receptacle 120, FIG. 2C is a front view of optical receptacle 120, FIG. 2D is a rear view of optical receptacle 120, FIG. 2E is a left side view of optical receptacle 120, and FIG. 2F is a right side view of optical receptacle 120. It is to be noted that, in the following description, the surface of optical receptacle 120 on which optical transmission member 130 is connected is referred to as “front surface.” It is to be noted that, as described above, optical module 100 according to the present embodiment includes a plurality of optical receptacles 120 having the same shape. In view of this, one of the plurality of optical receptacles 120 is described below.

As illustrated in FIG. 1 and FIGS. 2A to 2F, optical receptacle 120 is a member having a substantially cuboid shape. In the present embodiment, first recess 1201 having a rectangular prism shape is formed in the bottom surface of optical receptacle 120. Second recess 1202 having a substantially pentagonal prism shape is formed in the top surface of optical receptacle 120.

Optical receptacle 120 is formed of a material that is transparent to light of a wavelength used in optical communications. Examples of such a material include transparent resins such as polyetherimide (PEI) and cyclic olefin resin. In addition, the manufacturing method of optical receptacle 120 is not limited. Optical receptacle 120 is manufactured by injection molding, for example.

It is preferable that the materials of optical receptacles 120 of optical module 100 be identical to each other. With this configuration, the linear expansion coefficients of the optical receptacles 120 are identical to each other, and reduction in shape precision can be suppressed even in the case where optical module 100 is used under a high temperature.

Optical receptacle 120 includes first optical surface 121, reflection surface 122, second optical surface 123, first fitting part 124 and second fitting part 125. In the present embodiment, four first optical surfaces 121 and four second optical surfaces 123 are provided.

First optical surface 121 allows, to enter optical receptacle 120, first emission light L1 emitted from the photoelectric conversion element (light-emitting element) 112. At this time, first optical surface 121 allows, to enter optical receptacle 120, first emission light L1 emitted from the photoelectric conversion surface of photoelectric conversion element 112 while refracting the light so as to convert the light into collimate light.

The number of first optical surface 121 is not limited, and may be appropriately selected in accordance with the use. In the present embodiment, four first optical surfaces 121 are provided. On the bottom surface of optical receptacle 120, four first optical surfaces 121 are opposite to respective four photoelectric conversion elements 112. In the present embodiment, in the bottom surface of first recess 1201 provided in the rear side (bottom surface) of optical receptacle 120, four first optical surfaces 121 are disposed in a line along the short side direction of optical receptacle 120.

The shape of first optical surface 121 may be, but not limited to, a plane shape or a curved shape. In the present embodiment, first optical surface 121 is a convex lens surface protruding toward photoelectric conversion element 112. In addition, in plan view, first optical surface 121 has a circular shape. Preferably, the central axis of first optical surface 121 is perpendicular to the photoelectric conversion surface of photoelectric conversion element 112 (and the surface of substrate 111). In addition, preferably, the central axis of first optical surface 121 coincides with the optical axis of first emission light L1 emitted from photoelectric conversion element 112 (light-emitting element). In the present embodiment, the central axis of first optical surface 121 coincides with the optical axis of first emission light L1.

Reflection surface 122 reflects, toward second optical surface 123, first emission light L1 having entered optical receptacle 120 from first optical surface 121.

Reflection surface 122 is a part of the inner surface of second recess 1202 formed in the top surface of optical receptacle 120. Reflection surface 122 is tilted such that the distance to second optical surface 123 (the front surface of optical receptacle 120) decreases from the bottom surface toward the top surface of optical receptacle 120. The inclination angle of reflection surface 122 is not limited. In the present embodiment, the inclination angle of reflection surface 122 is 45° with respect to the optical axis of light incident on reflection surface 122 (in the present embodiment, first emission light L1). The shape of reflection surface 122 is not limited. In the present embodiment, reflection surface 122 has a plane shape. First incident light (emission light L1) is incident on reflection surface 122 at an incident angle greater than the critical angle.

Second optical surface 123 emits, toward the end surface of optical transmission member 130, first emission light L1 which has entered optical receptacle 120 from first optical surface 121 and has passed through the inside of optical receptacle 120. At this time, second optical surface 123 emits, toward the end surface of optical transmission member 130, first emission light L1 while converging first emission light L1.

The number of second optical surface 123 is not limited, and may be appropriately selected in accordance with the use. In the present embodiment, four second optical surfaces 123 are provided. On the front surface of optical receptacle 120, four second optical surfaces 123 are disposed opposite to respective end surfaces of four optical transmission members 130.

The shape of second optical surface 123 may be, but not limited to, a plane shape or a curved shape. In the present embodiment, the shape of second optical surface 123 is a convex lens surface protruding toward the end surface of optical transmission member 130. In plan view, second optical surface 123 has a circular shape. Preferably, the central axis of second optical surface 123 is perpendicular to the end surface of optical transmission member 130.

First fitting part 124 is fitted to second fitting part 125 described later. To be more specific, in optical receptacles 120 of optical module 100 according to the present embodiment, first fitting part 124 of one optical receptacle 120 is fitted to second fitting part 125 of another optical receptacle 120 adjacent to the one optical receptacle 120. With this configuration, the optical receptacles 120 are positioned and coupled to each other.

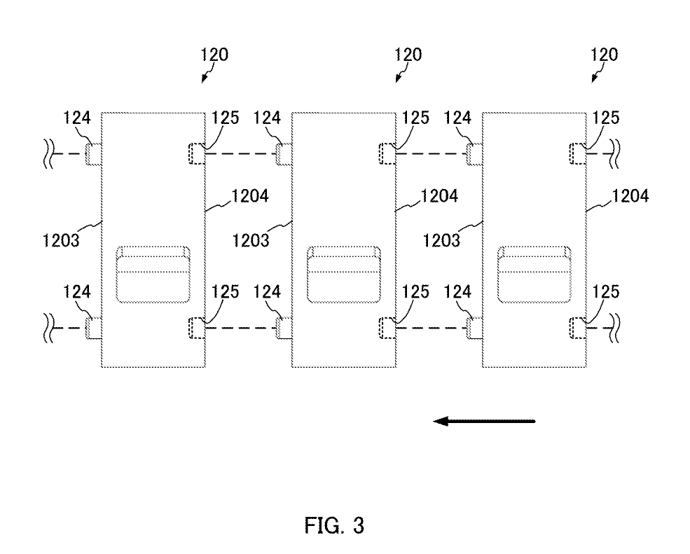

FIG. 3 is a schematic view for describing arrangement of first fitting part 124 and second fitting part 125 described later. FIG. 3 illustrates a state where first fitting part 124 and second fitting part 125 are fitted to each other to thereby couple three optical receptacles 120 together. In FIG. 3, the arrow indicates the direction in which first fitting part 124 and second fitting part 125 are fitted to each other.

As illustrated in FIG. 3, first fitting part 124 is disposed at a position opposite to second fitting part 125 in first side surface 1203 (in the present embodiment, the left side surface), which is not the surface (in the present embodiment, the bottom surface) in which first optical surface 121 is formed or the surface (in the present embodiment, the front surface) in which second optical surface 123 is formed.

The arrangement, shape, size, and number of first fitting part 124 are not limited as long as optical receptacles 120 of optical module 100 are appropriately coupled to each other, and the arrangement, shape, size, and number of first fitting part 124 correspond to the arrangement, shape, size, and number of second fitting part 125. The shape of first fitting part 124 is not limited as long as the shape can fit second fitting part 125, and is, for example, a recessed shape or a protruding shape. Examples of the plan shape of first fitting part 124 include a circular shape, an elliptical shape, a quadrangular shape and a polygonal shape. In the present embodiment, first fitting part 124 is two columnar-shaped protrusions.

Second fitting part 125 is fitted to first fitting part 124. To be more specific, in optical receptacles 120 of optical module 100 according to the present embodiment, second fitting part 125 of one optical receptacle 120 is fitted to first fitting part 124 of another optical receptacle 120 adjacent to the one optical receptacle 120. With this configuration, optical receptacles 120 are positioned and coupled to each other.

As illustrated in FIG. 3, second fitting part 125 is disposed at a position opposite to first fitting part 124 in second side surface 1204 (in the present embodiment, the right side surface) that is opposite to first side surface 1203 (in the present embodiment, the left side surface) with the light path of first emission light L1 therebetween.

The arrangement, shape, size, and number of second fitting part 125 are not limited as long as optical receptacles 120 of optical module 100 are appropriately coupled to each other, and correspond to the arrangement, shape, size, and number of first fitting part 124. The shape of second fitting part 125 is not limited as long as the shape can fit first fitting part 124, and is, for example, a recessed shape or a protruding shape. Examples of the plan shape of second fitting part 125 include a circular shape, an elliptical shape, a quadrangular shape and a polygonal shape. In the present embodiment, second fitting part 125 is two columnar-shaped recesses.

### Light Paths in Optical Module

Next, light paths of optical module 100 are described.

First emission light L1 emitted from photoelectric conversion element 112 (light-emitting element) enters optical receptacle 120 from first optical surface 121. At this time, first emission light L1 is converted by first optical surface 121 into collimate light. Next, first emission light L1 having entered optical receptacle 120 from first optical surface 121 is reflected by reflection surface 122 toward second optical surface 123. First emission light L1 reaching second optical surface 123 is emitted out of optical receptacle 120 from second optical surface 123, and reaches the end surface of optical transmission member 130.

In the above-mentioned manner, optical receptacle 120 according to the present embodiment can optically couple photoelectric conversion element 112 to the end surface of optical transmission member 130 in an appropriate manner.

### Effect

Optical receptacle 120 according to the present embodiment includes first fitting part 124 and second fitting part 125 which can be fitted to each other at both side surfaces (first side surface 1203 and second side surface 1204) of optical receptacle 120. With this configuration, in optical module 100 according to the present embodiment, the number of the channels can be freely changed in accordance with the required number of the channels by changing the number of optical receptacles 120 to be coupled.

In addition, in manufacture of resin optical receptacle 120, as the number of the channels increases, the processing time and the cost for the parts of the metal mold used for molding the optical surface (first optical surface 121, reflection surface 122 and second optical surface 123) increase. In contrast, in the present invention, it is unnecessary to newly manufacture a metal mold for optical receptacle 120 in accordance with the required number of the channels, and therefore the manufacturing time and the manufacturing cost for the metal mold of optical receptacle 120 can be reduced.

### Modification 1

While optical receptacle 120 includes four first optical surfaces 121 and four second optical surfaces 123 in the present embodiment, the numbers of first optical surfaces 121 and second optical surfaces 123 of the optical receptacle according to the embodiment of the present invention are not limited to this as long as at least one first optical surface 121 and at least one second optical surface 123 are provided.

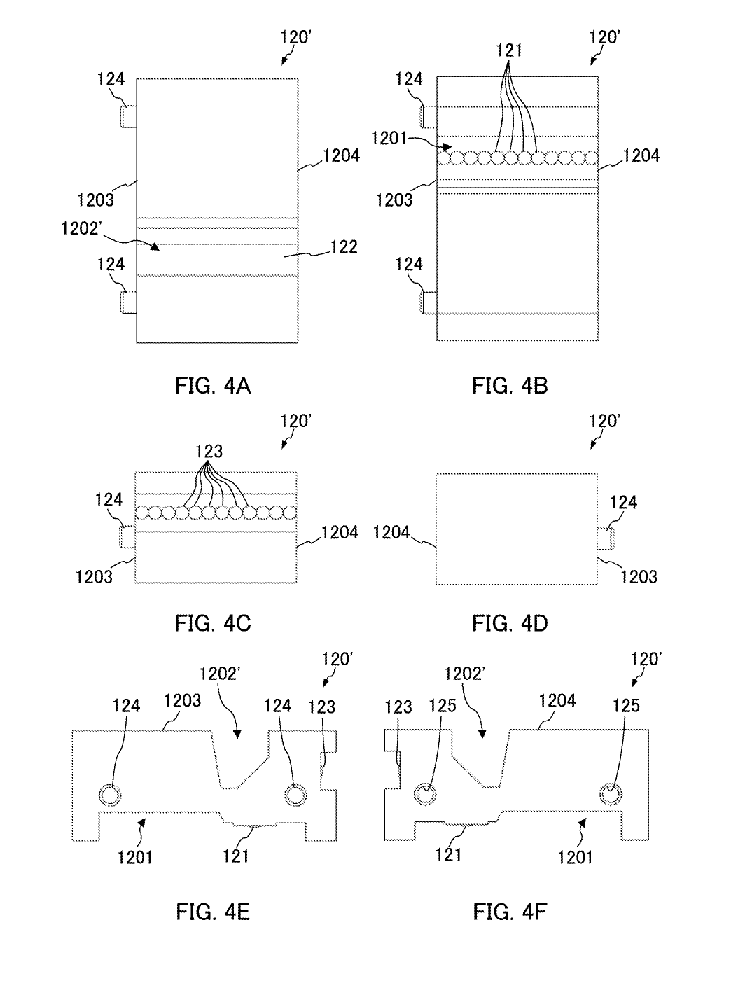

FIGS. 4A to 4F illustrate a configuration of optical receptacle 120′ according to Modification 1 of the embodiment. FIG. 4A is a plan view of optical receptacle 120′, FIG. 4B is a bottom view of optical receptacle 120′, FIG. 4C is a front view of optical receptacle 120′, FIG. 4D is a rear view of optical receptacle 120′, FIG. 4E is a left side view of optical receptacle 120′, and FIG. 4F is a right side view of optical receptacle 120′. As in optical receptacle 120′ according to Modification 1, twelve first optical surfaces 121 and twelve second optical surfaces 123 may be provided.

In addition, second recess 1202′ (referred to as “recess” in the claims) having a substantially pentagonal prism shape is formed in the top surface of optical receptacle 120′ according to Modification 1. Second recess 1202′ opens outward at first side surface 1203 and second side surface 1204. In this case, reflection surface 122 can be disposed entirely between first side surface 1203 and second side surface 1204, and therefore first optical surface 121 and second optical surface 123 can also be disposed entirely between first side surface 1203 and second side surface 1204. Accordingly, when a plurality of optical receptacles 120′ are coupled with each other, first optical surface 121 and second optical surface 123 are disposed with no gap therebetween even in a region near the coupling portion. The configuration in which second recess 1202′ formed in the top surface of optical receptacle 120′ opens outward at first side surface 1203 and second side surface 1204 is preferable in view of space-saving in the optical module.

It is to be noted that, in Modification 1, the channel is formed also in a region near first side surface 1203 and second side surface 1204, and accordingly first fitting part 124 and second fitting part 125 are disposed at positions that does not block the light path of optical receptacle 120′.

### Modification 2

The optical module according to the embodiment of the present invention is not limited to transmitting optical module 100 described above. For example, the optical module according to the embodiment of the present invention may be a receiving optical module. Now optical module 100″ according to Modification 2 of the embodiment is described. The configuration of receiving optical module 100″ is identical to the configuration of transmitting optical module 100 (see FIG. 1) except in photoelectric conversion element 112, and the function of receiving optical module 100″ differs from the function of transmitting optical module 100 only in the function of the receiving optical module. Identical components are assigned the same reference numerals and the description thereof will be omitted.

In the portion that functions as receiving optical module 100″, a light-receiving element, which serves as photoelectric conversion element 112, is disposed on substrate 111.

The light-receiving element receives second emission light L2 that has been emitted from the end surface of optical transmission member 130 and has passed through the inside of optical receptacle 120. To be more specific, the light-receiving element receives second emission light L2 at the photoelectric conversion surface (light reception surface). The number and the position of the light-receiving element are not limited. The light-receiving element is, for example, a photodiode (PD).

Optical receptacle 120 according to Modification 2 emits, toward photoelectric conversion element 112 (light-receiving element), second emission light L2 emitted from the end surface of optical transmission member 130.

Now functions of the optical surfaces (first optical surface 121, reflection surface 122, and second optical surface 123) of optical receptacle 120 in receiving optical module 100″ are described.

Second optical surface 123 allows, to enter optical receptacle 120, second emission light L2 emitted from the end surface of optical transmission member 130. At this time, second optical surface 123 allows, to enter optical receptacle 120, second emission light L2 emitted from the end surface of optical transmission member 130 while refracting the light so as to convert the light into collimate light. At this time, preferably, the central axis of second optical surface 123 coincides with the optical axis of second emission light L2 emitted from the end surface of optical transmission member 130. In the present embodiment, the central axis of second optical surface 123 and the optical axis of second emission light L2 coincide with each other.

Reflection surface 122 reflects, toward first optical surface 121, second emission light L2 having entered optical receptacle 120 from second optical surface 123.

First optical surface 121 emits, toward the photoelectric conversion element (light-receiving element) 112, second emission light L2 that has emitted from the end surface of optical transmission member 130 and has passed through the inside of optical receptacle 120. At this time, first optical surface 121 emits second emission light L2 toward the photoelectric conversion surface of photoelectric conversion element 112 while converging second emission light L2.

It is to be noted that second fitting part 125 is disposed at a position opposite to first fitting part 124 in second side surface 1204 (in Modification 2, the right side surface) that is opposite to first side surface 1203 (in Modification 2, the left side surface) with the light path of second emission light L2 therebetween.

Next, light paths of optical module 100″ are described.

Second emission light L2 emitted from the end surface of optical transmission member 130 enters optical receptacle 120 from second optical surface 123. At this time, second emission light L2 is converted by second optical surface 123 into collimate light. Next, second emission light L2 having entered optical receptacle 120 from second optical surface 123 is reflected by reflection surface 122 toward first optical surface 121. Second emission light L2 reaching first optical surface 121 is emitted out of optical receptacle 120 from optical surface 121, and reaches the photoelectric conversion surface (light reception surface) of photoelectric conversion element (light-receiving element) 112.

In the above-mentioned manner, optical receptacle 120 according to the present embodiment can optically couple photoelectric conversion element 112 and the end surface of optical transmission member 130 in an appropriate manner.

It is to be noted that the optical module of the embodiment of the present invention is not limited to transmitting optical module 100 or receiving optical module 100″ described in the embodiment and the above-mentioned modification 2. For example, the optical module may be a transmitting and receiving optical module including a portion that functions as a transmitting optical module and a portion that functions as a receiving optical module.

While optical receptacle 120 includes reflection surface 122 in the embodiment, the optical receptacle according to the embodiment of the present invention is not limited to this. For example, optical receptacle 120 may not include reflection surface 122. In this case, first optical surface 121 and second optical surface 123 are disposed opposite to each other in optical receptacle 120. In the portion that functions as the transmitting optical module, first emission light L1 emitted from the photoelectric conversion element (light-emitting element) enters optical receptacle 120 from first optical surface 121, and is then emitted out of optical receptacle 120 from second optical surface 123 without being reflected by reflection surface 122, thereby reaching the end surface of optical transmission member 130. On the other hand, in the portion that functions as the receiving optical module, second emission light L2 emitted from the end surface of optical transmission member 130 enters optical receptacle 120 from second optical surface 123, and is then emitted out of optical receptacle 120 from first optical surface 121 without being reflected by reflection surface 122, thereby reaching the photoelectric conversion surface of photoelectric conversion element (light-receiving element) 112.

Further, a reflection film composed of a thin film of a metal having a high light reflectance (such as Al, Ag and Au) may be formed on reflection surface 122. In the case where reduction of the number of components is desired to be prioritized, it is preferable to employ a configuration in which only a total reflection surface is utilized.

This application is entitled to and claims the benefit of Japanese Patent Application No. 2016-043302 filed on Mar. 7, 2016, the disclosure each of which including the specification, drawings and abstract is incorporated herein by reference in its entirety.

### INDUSTRIAL APPLICABILITY

The optical receptacle and the optical module according to the embodiment of the present invention are suitable for optical communications using an optical transmission member, for example.

### REFERENCE SIGNS LIST

100, 100″ Optical module
110 Photoelectric conversion device
111 Substrate
112 Photoelectric conversion element
120, 120′ Optical receptacle
1201 First recess
1202, 1202′ Second recess
121 First optical surface
122 Reflection surface
123 Second optical surface
124 First fitting part
125 Second fitting part
130 Optical transmission member
L1 First emission light
L2 Second emission light

1. An optical receptacle configured to be disposed between a photoelectric conversion element and an optical transmission member, and configured to optically couple the photoelectric conversion element with an end surface of the optical transmission member, the optical receptacle comprising:
a first optical surface configured to allow incidence of first emission light emitted from the photoelectric conversion element, or to emit, toward the photoelectric conversion element, second emission light which has been emitted from the end surface of the optical transmission member and has passed through inside of the optical receptacle;
a second optical surface configured to emit, toward the end surface of the optical transmission member, the first emission light which has entered the optical receptacle from the first optical surface and has passed through the inside of the optical receptacle, or to allow incidence of the second emission light emitted from the end surface of the optical transmission member;
a first fitting part disposed in a first side surface which is neither a surface in which the first optical surface is formed nor a surface in which the second optical surface is formed; and
a second fitting part disposed in a second side surface which is opposite to the first side surface with a light path of the first emission light or a light path of the second emission light therebetween, the second fitting part having a shape capable of being fitted to the first fitting part.

2. The optical receptacle according to claim 1, wherein the optical receptacle is made of resin.

3. The optical receptacle according to claim 1, wherein four first optical surfaces are provided as the first optical surface and four second optical surfaces are provided as the second optical surface.

4. The optical receptacle according to claim 1, wherein twelve first optical surfaces are provided as the first optical surface and twelve second optical surfaces are provided as the second optical surface.

5. The optical receptacle according to claim 1, further comprising a reflection surface configured to reflect, toward the second optical surface, the first emission light which has entered the optical receptacle from the first optical surface, or to reflect, toward the first optical surface, the second emission light which has entered the optical receptacle from the second optical surface.

6. The optical receptacle according to claim 5, wherein:
the reflection surface is a part of an inner surface of a recess formed in the optical receptacle; and
the recess opens outward at the first side surface and the second side surface.

7. An optical module comprising:
a substrate;
a photoelectric conversion element disposed on the substrate; and
a plurality of the optical receptacles according to claim 1, the plurality of the optical receptacles being disposed on the substrate such that the first optical surface is opposite to the photoelectric conversion element,
wherein the plurality of optical receptacles are coupled with each other such that the first fitting part and the second fitting part adjacent to each other are engaged with each other.
